(19) United States
(12) Patent Application Publication
(10) Pub. No.: US 2007/0085980 A1
(43) Pub. Date: Apr. 19, 2007

(54) Projection assembly

(76) Inventors: Scott Lerner, Corvallis, OR (US); Anurag Gupta, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/253,401

(22) Filed: Oct. 18, 2005

(51) Int. Cl. G03B 21/28

(52) U.S. Cl. 353/99

(57) ABSTRACT

A projection assembly is provided herein for use in display systems. According to one exemplary embodiment, the projection assembly includes a multi-mirror reflective ring-field type lens assembly. According to such an exemplary embodiment, the projection assembly also includes a light modulator assembly in optical communication with the multi-mirror ring-field type lens assembly.

### BACKGROUND

Display systems project an image or series of images on a display surface. In particular, light is frequently modulated by one or more light modulator panels to form one or more image. The modulated light is then passed through display optics, which frequently magnifies the modulated light and focuses the light onto a display surface.

The display optics often includes a series of refractive lenses to provide the desired magnification and focus. In many cases, such as where high magnification is desired, many individual lenses may be required to accurately display the output of the light modulator panel on the display surface. Such lenses may also be relatively large, resulting in an overall larger size and greater expense for the display system.

### SUMMARY

A projection assembly is provided herein for use in display systems. According to one exemplary embodiment, the projection assembly includes a multi-mirror reflective ring-field type lens assembly. According to such an exemplary embodiment, the projection assembly also includes a light modulator assembly in optical communication with the multi-mirror ring-field type lens assembly.

### BRIEF DESCRIPTION OF THE DRAWINGS

The accompanying drawings illustrate various embodiments of the present apparatus and method and are a part of the specification. The illustrated embodiments are merely examples of the present apparatus and method and do not limit the scope of the disclosure.

FIG. 1 illustrates a display system according to one exemplary embodiment.

FIG. 2 illustrates a projection assembly according to one exemplary embodiment.

FIG. 3 illustrates a sub-frame at a first location according to one exemplary embodiment.

FIG. 4 illustrates a sub-frame at a second location according to one exemplary embodiment.

FIG. 5 illustrates sub-frames at first and second locations according to one exemplary embodiment.

FIG. 6 illustrates a projection assembly according to one exemplary embodiment.

FIG. 7 illustrates a projection assembly according to one exemplary embodiment.

Throughout the drawings, identical reference numbers designate similar, but not necessarily identical, elements.

### DETAILED DESCRIPTION

Display optics are provided herein for use in display systems, such as projection televisions, projectors, and the like. In particular, according to several exemplary embodiments discussed herein, the projection assembly includes a multi-mirror ring-field type projection lens. Such projection lens may provide cost and weight reduction. Further, multi-mirror ring-field type projection lenses may provide a high degree of wave-front correction and distortion correction, thereby providing for high quality displayed images.

Several projection assemblies will be discussed below. A projection assembly that includes a compact four mirror ring-field type projection lens in an all-reflective configuration will first be discussed, followed by a discussion of a compact four mirror ring-field type projection lens that includes a compound refractive lens, and a discussion of other types of projection lenses. As used herein, a compact configuration shall be understood broadly to mean lens configuration with a length of about 300 mm. Long throw shall be broadly understood to mean a projection configuration in which the distance to the screen relative to the diameter of the screen has a ratio of about 3:1. Similarly, short throw shall be broadly understood to mean a projection configuration in which the distance to the screen relative to the diameter of the screen has a ratio of about 1:2.

In the following description, for purposes of explanation, numerous specific details are set forth in order to provide a thorough understanding of the present apparatus. It will be apparent, however, to one skilled in the art that the present method and apparatus may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Display System

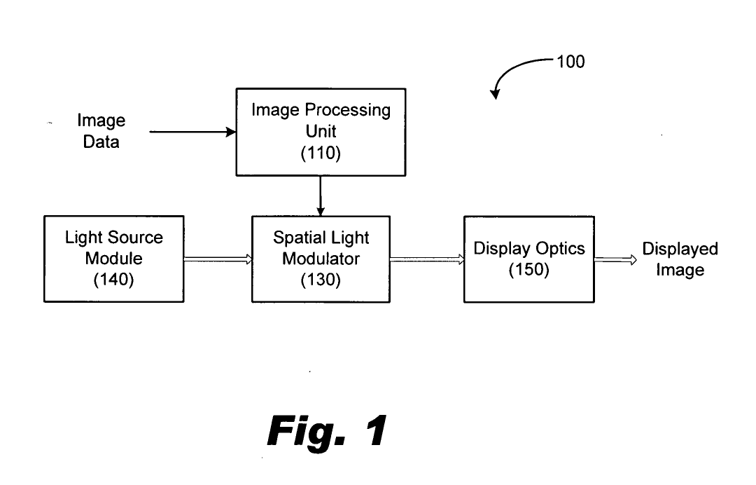

FIG. 1 illustrates an exemplary display system (100). The components of FIG. 1 are exemplary only and may be modified or changed as best serves a particular application. As shown in FIG. 1, image data is input into an image processing unit (110). The image data defines an image that is to be displayed by the display system (100). While one image is illustrated and described as being processed by the image processing unit (110), it will be understood by one skilled in the art that a plurality or series of images may be processed by the image processing unit (110).

The image processing unit (110) performs various functions including controlling a spatial light modulator assembly (130). The light source module (140) directs light toward the spatial light modulator assembly (130). The spatial light modulator assembly (130) includes one or more arrays of light modulator devices. The light modulator devices may be in the form of micro-electro mechanical (MEMS) devices, or pixels, which are configured to modulate light incident thereon. The display optics (150) direct the modulated light onto a display surface to form an image.

According to several exemplary embodiments discussed below, the display optics (150) includes a plurality of mirrors. These mirrors are configured to reflect and magnify the modulated light and to display the light onto a viewing surface. The viewing surface may be, but is not limited to, a screen, television, wall, liquid crystal display (LCD), or computer monitor.

Projection Assembly

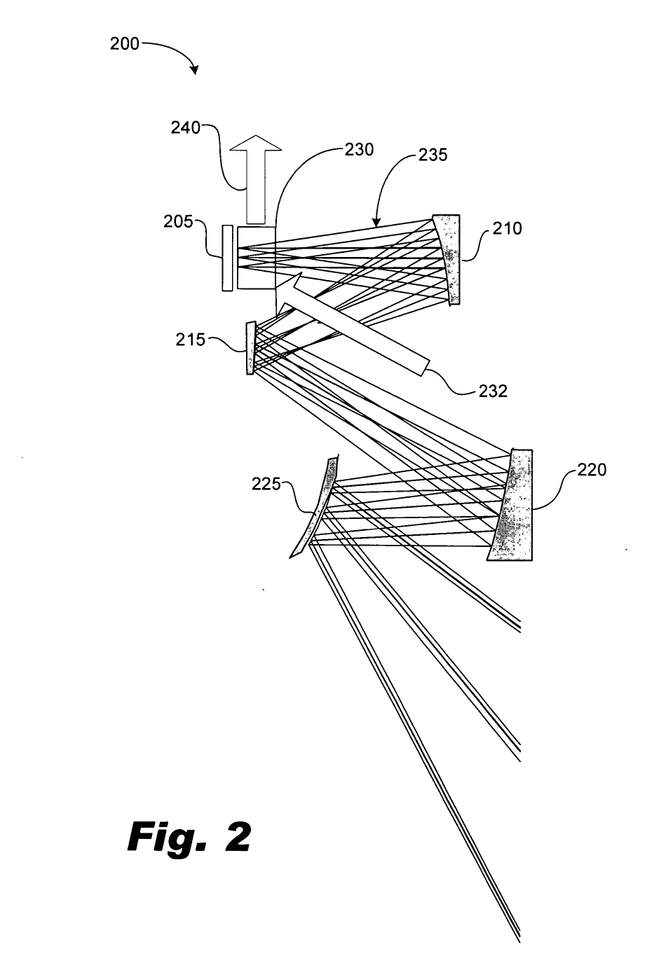

FIG. 2 illustrates an exemplary projection assembly (200). The projection assembly (200) includes a light modulator panel (205) and display optics that includes a mirror assembly. The mirror assembly includes a first mirror (210), a second mirror (215), a third mirror (220), and a fourth mirror (225). As will be discussed in more detail below, according to the present exemplary embodiment, these mirrors form a compact four mirror ring-field type lens. Such a system may provide magnification of the output of the light modulator panel (205) while directing the output to a display surface, such as a screen.

According to the present exemplary embodiment, the first, second, third, and fourth mirrors (210, 215, 220, 225) are located to one side of the light modulator panel (205). For ease of reference only, the display surface will be referred to as the front. Thus, according to the exemplary embodiment illustrated in FIG. 2, the first, second, third, and fourth mirrors (210, 215, 220, 225) are located in front of the light modulator panel (205). For this configuration the distance from the projection lens to the screen is relatively short and can be referred to as a short-throw type projection assembly.

Light modulated by the light modulator panel (205) is directed to the display optics. The ring field width of the display optics may be sufficient to cover the light modulator panel (205), which according to the present exemplary embodiment may be between about 20-30 mm. The display optics may also have a numerical aperture in a range of about 0.1 to 0.2 or greater and an F number within a range of about 2.5 to about 5.0, such as an F number of approximately 3.5. These characteristics may provide a magnification of the output of the light modulator panel (205) of approximately between 20 and 100 times, such as a magnification of about 70 times at a distance of about one meter from the light modulator panel (205). One exemplary mirror assembly will now be described in more detail.

The projection assembly (200) according to the present exemplary embodiment includes a total internal reflection prism (TIR prism) (230). Incoming light (232) is directed to the TIR prism (230). The TIR prism (230) directs the incoming light (232) to the light modulator panel (205). The TIR prism (230) may include a first and second internal reflection interfaces or may only include a first internal reflection surface. For the case of two internal reflection surfaces, the first and second internal reflection interfaces intersect, such that an “X” is formed. The first internal reflection interface directs the light (232) to the light modulator panel (205). The second internal reflection interface may direct light away from the projection lens.

The light modulator panel (205) according to the present exemplary embodiment may be a reflective-type light modulator panel that modulates the incoming light (232) to form display light (235) and non-display light (240). The TIR prism (230) spatially separates the display light (235) and the non-display light (240). In particular, according to the present exemplary embodiment, display light is transmitted through the first and second internal reflection interfaces while non-display light is reflected off the second internal reflection interface and directed away from the display optics. For example, the non-display light may be directed to a beam dump.

The beam dump reduces or minimizes the possibility that the non-display light (240) will reach display optics. According to one exemplary embodiment, the beam dump includes a light-absorbing surface that is shaped to trap and absorb light that is incident thereon. By absorbing substantially all of the non-display light (240) that is incident thereon, the beam dump reduces or minimizes the possibility that the non-display light (240) will reach the display optics. As a result, directing the non-display light (240) away from the projection lens and to the beam dump may increase the contrast ratio of the projection assembly (200).

As introduced, display light (235) from the light modulator panel (205) is directed to the display optics. In particular, the display light (235) is first incident on the first mirror (210). The first and second mirrors (210, 215) may form a Schwarzschild-type system. Accordingly, the first mirror (210) may be a concave mirror with a radius of curvature of about 165 mm, a maximum aspheric departure of about 9 μm, and a conic constant (k) of about 0.189 mm. In general, aspheric departure refers to the divergence of the shape of an actual mirror as compared to a sphere with a given radius of curvature. The position and shape of the first mirror (210) are such that light reflected from the first mirror (210) is directed to the second mirror (215).

As introduced, the first and second mirrors (210, 215) may operate as a Schwarzchild-type lens. Accordingly, the second mirror (215) according to the present exemplary embodiment may be a convex mirror with radius of curvature of about 140 mm, a maximum aspheric departure of about 9 μm, and a conic constant (k) of about 1.25 mm. Additionally, according to one exemplary embodiment, the second mirror (215) may be coupled to wobulation control.

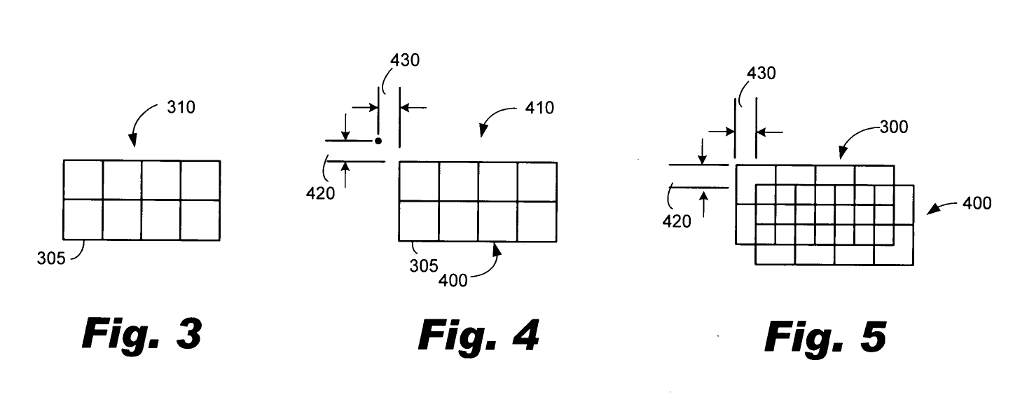

FIGS. 3-5 illustrate an exemplary embodiment wherein a number of image sub-frames are generated for a particular image. As illustrated in FIGS. 3-5, the exemplary image processing unit (110; FIG. 1) generates two image sub-frames for a particular image. More specifically, the image processing unit (110; FIG. 1) generates a first sub-frame (300) and a second sub-frame (400) for the image frame.

The first sub-frame (300) and the second sub-frame (400) each comprise a data array of a subset of the image data for the corresponding image frame. In particular, the first and second sub-frames (300, 400) each include a plurality of pixels (305). Although the exemplary image processing unit (110; FIG. 1) generates two image sub-frames in the example of FIGS. 3-5, it will be understood that two image sub-frames are an exemplary number of image sub-frames that may be generated by the image processing unit (110; FIG. 1) and that any number of image sub-frames may be generated according to an exemplary embodiment.

In one embodiment, as illustrated in FIGS. 3-5, the first image sub-frame (300) is displayed in a first image sub-frame location (310). The second sub-frame (400) is displayed in a second image sub-frame location (410) that is offset from the first sub-frame location (310) by a vertical distance (420) and a horizontal distance (430). As such, the second sub-frame (400) is spatially offset from the first sub-frame (300) by a predetermined distance. In one illustrative embodiment, as shown in FIG. 5, the vertical distance (420) and horizontal distance (430) are each approximately one-half of one pixel. However, the spatial offset distance between the first image sub-frame location (310) and the second image sub-frame location (410) may vary as best serves a particular application.

In alternative embodiments, the first sub-frame (300) and the second sub-frame (400) may only be offset in either the vertical direction or in the horizontal direction. In the illustrated embodiment, the second mirror (215) is configured to offset the beam of light between the second mirror (215) and the display optics (150; FIG. 1) such that the first and second sub-frames (300, 400; FIG. 5) are spatially offset from each other both vertically and horizontally.

As illustrated in FIG. 5, the light reflected from the second mirror (215; FIG. 2) is shifted between displaying the first sub-frame (300) in the first image sub-frame location (310) and displaying the second sub-frame (400) in the second image sub-frame location (410) that is spatially offset from the first image sub-frame location (310). As such, the pixels of the first sub-frame (300) overlap the pixels of the second sub-frame (400). In one embodiment, the display system (100; FIG. 1) completes one cycle of displaying the first sub-frame (300) in the first image sub-frame location (310) and displaying the second sub-frame (400) in the second image sub-frame location (410) resulting in a displayed image with an enhanced apparent resolution. Thus, the second sub-frame (400) is spatially and temporally displayed relative to the first sub-frame (300).

Thus, by generating a first and second sub-frame (300, 400) and displaying the two sub-frames in the spatially offset manner as illustrated in FIGS. 3-5, twice the amount of pixel data is used to create the finally displayed image as compared to the amount of pixel data used to create a finally displayed image without using the image sub-frames and wobulation. Accordingly, with two-position processing, the resolution of the finally displayed image is increased by a factor of approximately 1.4 or the square root of two.

In addition, the display system (100; FIG. 1) may be configured to provide four sub-frames and to shift the second mirror (215, FIG. 2) to form the four sub-frames for an image frame. Thus, by generating four image sub-frames and displaying the four sub-frames in the spatially offset manner, four times the amount of pixel data is used to create the finally displayed image as compared to the amount of pixel data used to create a finally displayed image without using the image sub-frames. Accordingly, with four-position processing, the resolution of the finally displayed image is increased by a factor of two or the square root of four.

Thus, as shown by the examples in FIGS. 3-5, by generating a number of image sub-frames for an image frame and spatially and temporally displaying the image sub-frames relative to each other, the display system (100; FIG. 1) can produce a displayed image with a resolution greater than that which the modulator panel (205; FIG. 2) is configured to display. In one illustrative embodiment, for example, with image data having a resolution of 800 pixels by 500 pixels and the modulator panel (205; FIG. 2) having a resolution of 800 pixels by 500 pixels, four-position processing by the display system (100; FIG. 1) with resolution adjustment of the image data produces a displayed image with a resolution of 4000 pixels by 1200 pixels.

In addition, by overlapping pixels of image sub-frames, the display system (100; FIG. 1) may reduce the undesirable visual effects caused, for example, by a defective pixel. For example, if four sub-frames are generated and displayed in offset positions relative to each other, the four sub-frames effectively diffuse the undesirable effect of the defective pixel because a different portion of the image that is to be displayed is associated with the defective pixel in each sub-frame. A defective pixel is defined to include an aberrant or inoperative display pixel such as a pixel which exhibits only an “on” or “off” position, a pixel that produces less intensity or more intensity than intended, and/or a pixel with inconsistent or random operation.

Referring again to FIG. 2, the second mirror (215) directs light to the third mirror (220). According to the present exemplary embodiment the third mirror (220) may be a convex mirror with radius of curvature of about 370 mm, a maximum aspheric departure of about 117 μm, and a conic constant of about −0.52 mm. The position and shape of the third mirror (220) are such that light reflected from the third mirror (220) is directed to the fourth mirror (225). The position and shape of the fourth mirror (225) are such that light incident thereon is reflected to a display surface. While dimensions have been provided corresponding to aspheric departure, radius of curvature, and a conic constants, those of skill in the art will appreciate that the dimensions may be adjusted or changed as desired to form a suitable reflection-based lens assembly, such as a compact ring-field reflective lens assembly.

The light reflected to the display surface from the fourth mirror (225) may have a net magnification of between about 20 to 100, such as a magnification of about 70. Further, the display optics may provide accurate reproduction of the output of the light modulator panel (205). Thus far, one exemplary projection assembly (200) has been discussed. Those of skill in the art will appreciate that other configurations are possible.

### ALTERNATIVE EMBODIMENTS

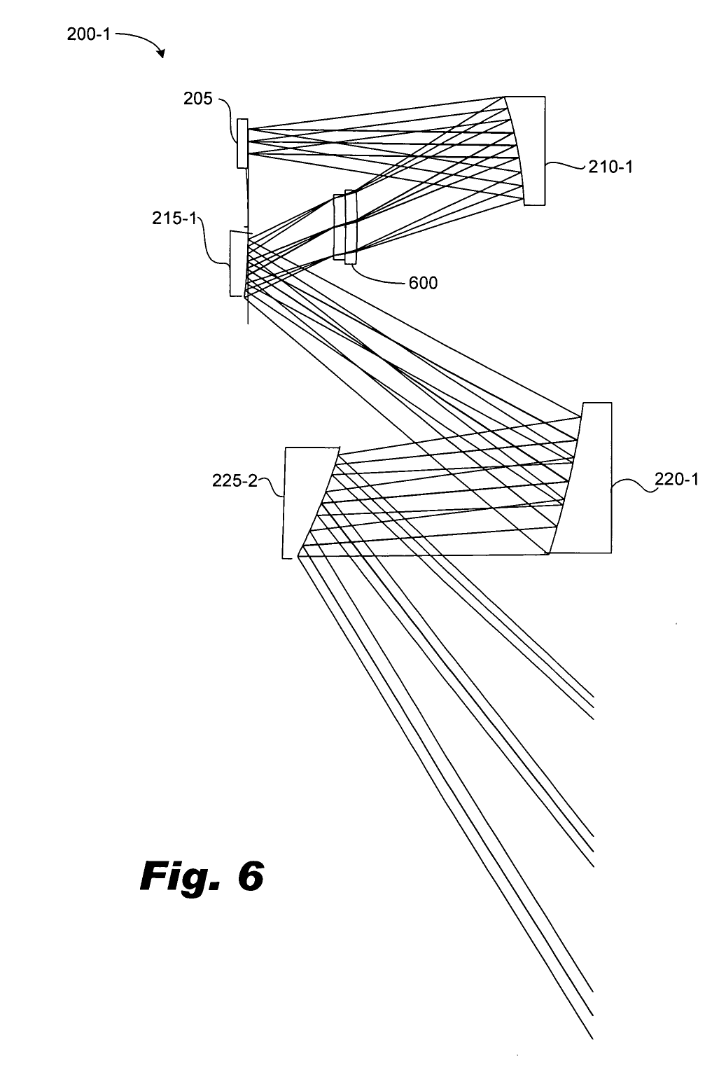

FIG. 6 illustrates a projection assembly (200-1) that includes a compound refractive lens, such as an achromatic doublet (600) located in the optical path. According to the present exemplary embodiment, the achromatic doublet (600) may be located near the optical pupil of the projection assembly. The use of a compound lens, such as the achromatic doublet (600) may provide for correction of aberrations. For example, the lens combinations of the compound lens may be chosen and combined accordingly to correct coma and field curvature. According to such a configuration, the first and second mirrors (210-1, 215-1) may form a Schwarzschild-type system. While an achromatic doublet (600) is described, those of skill in the art will appreciate that any number of lenses may be combined to correct any number of aberrations as desired.

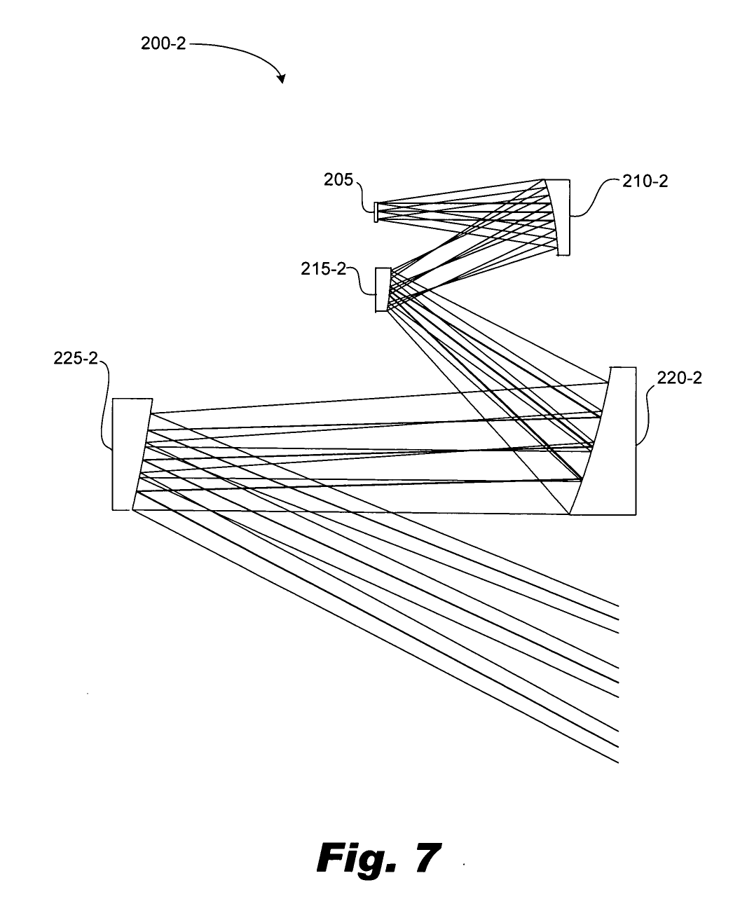

In addition, the mirrors may be arranged in other configurations. For example, according to one exemplary embodiment illustrated in FIG. 7, a compact four mirror ring-field type lens may be used wherein a fourth mirror (225-2) is located behind the light modulator panel (205). Such a configuration may generally be referred to as a long-throw type compact four mirror ring field-type lens.

According to such an exemplary embodiment, the lens assembly (200-2) also includes first, second, and third mirrors (210-2, 215-2, and 220-2 respectively). The first mirror (210-2) of the present exemplary long-throw configuration is a concave mirror with a radius of curvature of about −160 mm, a maximum aspheric departure of about 22 μm, and a conic constant of about 0.3 mm. The second mirror (215-2) according to the present exemplary embodiment is a convex mirror with a radius of curvature of about −300 mm, a maximum aspheric departure of about 7 μm, and a conic constant of about 10.74 mm. The third mirror (220-2) according to the present exemplary embodiment is a concave mirror with a radius of curvature of about −600 mm, a maximum aspheric departure of about 232 μm, and a conic constant of about 16.25 mm. The fourth mirror (225-2) according to the present exemplary embodiment is a convex mirror with a radius of curvature of about 960 mm, such as a radius of curvature of about 962.79 mm, a maximum aspheric departure of about 880 μm, and a conic constant of about 58 mm. Such a system may provide wavefront correction of better than about 1/20 wave and distortion of less than about 0.5% across the displayed image.

Compact four mirror ring field-type lenses have been discussed herein. Those of skill in the art will appreciate that other configurations may also be used. These configurations include, without limitation, experimental test stand (ETS), small angle design, and symmetric type four mirror ring field-type lenses. Further, the exemplary embodiments discussed thus far have made use of four mirrors. Those of skill in the art will appreciate that any number of mirrors may be utilized, including five, six, or more mirrors.

In conclusion, assemblies are provided herein for use in display systems, such as projection televisions, projectors, and the like. In particular, according to several exemplary embodiments discussed herein, the projection assembly includes a multi-mirror ring field-type projection lens. Such projection lens may provide cost and weight reduction. Further, multi-mirror ring field-type projection lenses may provide a high degree of wave front correction and distortion correction, thereby providing for high quality displayed images.

The preceding description has been presented only to illustrate and describe the present method and apparatus. It is not intended to be exhaustive or to limit the disclosure to any precise form disclosed. Many modifications and variations are possible in light of the above teaching. It is intended that the scope of the disclosure be defined by the following claims.

What is claimed is:

1. A projection assembly, comprising:
a multi-mirror reflective ring-field type lens assembly; and
a light modulator assembly in optical communication with said multi-mirror ring-field type lens assembly.

2. The assembly of claim 1, wherein said multi-mirror reflective ring-field type lens assembly is a compact ring-field type lens assembly.

3. The assembly of claim 2, wherein said compact ring-field type lens assembly comprises a short-throw ring-field type lens assembly.

4. The assembly of claim 2, wherein said compact ring-field type lens assembly comprises a long-throw ring-field type lens assembly.

5. The assembly of claim 1, wherein said short-throw ring-field type lens assembly includes first, second, third, and fourth mirrors, said first and third mirrors being concave mirrors and said second and fourth mirrors being convex mirrors.

6. The assembly of claim 5, wherein said first and second mirrors form a Schwarzchild system.

7. The assembly of claim 5, further comprising an achromatic doublet located between said second and third mirrors.

8. The assembly of claim 5, wherein said second mirror is coupled to wobulation control.

9. The assembly of claim 5, wherein said first mirror has a radius of curvature of about 165 mm, a maximum aspheric departure of about 9 μm, and a conic constant of about 0.189 mm; said second mirror has a radius of curvature of about 140 mm, a maximum aspheric departure of about 9 μm, and a conic constant of about 1.25 mm; said third mirror has a radius of curvature of about 370 mm, a maximum aspheric departure of about 117 μm, and a conic constant of about −0.52 mm; and said fourth mirror has a radius of curvature of about 577 mm, a maximum aspheric departure of about 125 μm, and a conic constant of about −3.7 mm.

10. The assembly of claim 5, said first mirror has a radius of curvature of about −160 mm, a maximum aspheric departure of about 22 μm, and a conic constant of about 0.3 mm; said second mirror has a radius of curvature of about −300 mm, a maximum aspheric departure of about 7 μm, and a conic constant of about 10.74 mm; said third mirror has a radius of curvature of about −600 mm, a maximum aspheric departure of about 232 μm, and a conic constant of about −16.25 mm; and said fourth mirror has a radius of curvature of about −962.79 mm, a maximum aspheric departure of about 880 μm, and a conic constant of about −58 mm.

11. A display system, comprising:
a light source;
a light modulator assembly coupled to said light source; and
a multi-mirror reflective ring field-type lens assembly coupled to said light modulator assembly.

12. The assembly of claim 11, further comprising a total internal reflection prism at least partially between said light source and said light modulator assembly.

13. The assembly of claim 12, and further comprising a beam dump coupled to said light modulator assembly.

14. The display system of claim 11, wherein said light modulator assembly comprises a reflective-type light modulator assembly.

15. The display system of claim 14, wherein said ring field type-lens assembly comprises a compact ring-field type lens assembly.

16. The display system of claim 15, wherein said compact ring-field type lens assembly comprises four mirrors.

17. The display system of claim 15, wherein said compact ring-field type lens assembly comprises a short-throw compact ring-field type lens.

18. The display system of claim 15, wherein said compact ring-field type lens assembly comprises a long-throw compact ring-field type lens.

19. A method of modulating light to form a display image, comprising:
generating light;
modulating said light to form an image; and
magnifying and focusing said image with a ring field-type lens assembly.

20. The method of claim 19, wherein magnifying said image includes providing a magnification of between about 50 to about 100.

21. The method of claim 20, wherein magnifying said image includes providing a magnification of about 70.

22. The method of claim 19, wherein generating light includes generating sequentially color-varying light.

23. The method of claim 19, wherein modulating said light comprises forming display light and non-display light.
